(19) United States
(12) Patent Application Publication
(10) Pub. No.: US 2026/0023594 A1
(43) Pub. Date: Jan. 22, 2026

(54) Core Scheduling Based on Energy Crossover

(71) Applicants: Advanced Micro Devices, Inc, Santa Clara, CA (US); ATI Technologies ULC, Markham (CA)

(72) Inventors: Bharath Prabhu Perdoor, Cedar Park, TX (US); Poonam Aggrwal, Austin, TX (US); Indrani Paul, Austin, TX (US); Jun Huang, Markham (CA)

(21) Appl. No.: 18/779,207

(22) Filed: Jul. 22, 2024

(51) Int. Cl. G06F 9/48

(52) U.S. Cl. CPC G06F 9/4881

(57) ABSTRACT

Core scheduling based on energy crossover is described. In one or more implementations, a system includes a plurality of cores, a controller configured to communicate feedback associated with efficiency of the plurality of cores, and an operating system. The operating system is configured to receive the feedback and adjust core scheduling responsive to at least one of the plurality of cores operating in an inefficient state based on the feedback. The controller may monitor operation of the cores, determine crossover points indicating transitions between efficient and inefficient frequency ranges for the cores, and detect when operating frequencies are proximate to the crossover points. Core scheduling adjustments may include migrating work between cores or reducing workload while maintaining operating frequencies to optimize efficiency.

### BACKGROUND

A computing system having a heterogeneous architecture utilizes multiple types of processors or cores. Typically, instructions are assigned to the most suitable processor type to optimize performance and energy efficiency. By using the best-suited processor for each task, heterogeneous architectures can achieve higher performance and lower power consumption compared to homogeneous systems.

### BRIEF DESCRIPTION OF THE DRAWINGS

FIG. 1 is a block diagram of a non-limiting example system having a heterogeneous architecture and configured to schedule cores based on energy crossover.

FIG. 2 is a non-limiting example of a graph plotting power consumption against frequency for two different core types showing a crossover.

FIG. 3 depicts a non-limiting example procedure for core scheduling based on energy crossover.

FIG. 4 is a block diagram of a processing system configured to execute one or more applications.

### DETAILED DESCRIPTION

Core scheduling based on energy crossover is described. In one or more implementations, a system includes a plurality of cores, a controller configured to communicate feedback associated with efficiency of the plurality of cores, and an operating system. The operating system is configured to receive the feedback and adjust core scheduling responsive to at least one of the plurality of cores operating in an inefficient state based on the feedback. In one or more implementations, the controller is configured to monitor operation of the cores, determine crossover points indicating transitions between efficient and inefficient frequency ranges for the cores, and detect when operating frequencies are proximate to the crossover points. Core scheduling adjustments can include migrating work between cores or reducing workloads of the cores while maintaining operating frequencies to optimize efficiency.

In accordance with the described techniques, core scheduling based on energy crossover is utilized in a system having a “heterogeneous architecture.” A heterogeneous architecture refers to a system that uses multiple types of processors or cores. Typically, instructions, also referred to herein as “threads,” are assigned to the most suitable processor type to optimize performance and energy efficiency. By using the best-suited processor for each task, heterogeneous architectures can achieve higher performance and lower power consumption compared to homogeneous systems.

For example, a system having a heterogeneous architecture may include a set of “high-performance cores” and a set of “efficiency cores”. With conventional approaches, heterogenous systems may schedule tasks to the cores of a processing unit solely based on core type. For example, such conventional systems may schedule tasks that benefit from high performance to performance cores and tasks that are relatively tolerant of latency to efficiency cores, without considering other runtime characteristics of or observations about those cores. As part of this, conventional approaches leverage CPUID, which reports about the architecture of a processing unit to an operating system. This includes reporting core types of the architecture’s cores to the operating system. When scheduling tasks to the cores of a heterogeneous architecture, a conventionally configured scheduler evaluates the core types of the cores as indicated by CPUID and directs a task to a core based on its core type as indicated by CPUID. However, this simplistic approach fails to account for changes in efficiency (in terms of power consumption) of the cores when operating at different (e.g., higher, or lower) frequencies.

Alternatively or additionally, in conventional approaches, firmware of the processing unit restricts (e.g., caps) a frequency at which cores execute threads, using one or more known techniques for restricting the frequency. However, this limits the throughput (or “performance”) of the cores to the frequency cap, i.e., the frequency at the cap is the maximum rate at which the cores can execute threads. In one or more such approaches, the processing unit firmware restricts the frequency without interacting with an operating system. Alternatively or additionally, in some conventional approaches, an operating system performs one or more actions that limit the throughput of the cores, such as by using one or more Advanced Configuration and Power Interface (ACPI) mechanisms.

In contrast to such conventional techniques, the systems, devices, and techniques described herein are configured to account for changes in efficiency of cores at different frequencies when scheduling the cores to execute one or more threads. In one or more implementations, a scheduler is configured to schedule different cores of a plurality of cores to execute one or more threads. In contrast to conventionally configured schedulers, however, the scheduler is capable of scheduling execution of a thread on one or more cores in a manner that accounts for changes in efficiency (in terms of power consumption) of the cores at different frequencies (e.g., of executing threads per interval of time). For example, the scheduler is capable of adjusting the scheduling of a thread on one or more cores in a manner that accounts for changes in efficiency of different core types and/or of individual cores (e.g., due to manufacturing tolerances and/or wear) across a range of operating frequencies.

In order to do so, feedback is provided to the operating system during runtime. By way of example, the feedback indicates that a crossover point has been reached at which a core transitions between a first frequency range and a second frequency range, where in the first frequency range the core executes threads relatively efficiently and in the second frequency range the core executes threads relatively less efficiently, or vice versa.

Based on the feedback, the operating system performs any of a variety of operations to adjust scheduling threads on the cores for execution. For example, the operating system may stop scheduling threads to one or more cores which are indicated as operating below but “near” a crossover point, at the crossover point, and/or above the crossover point (e.g., in an inefficient state), and migrates the work onto one or more cores operating more efficiently (e.g., below the crossover point in an efficient state). Alternatively or additionally, the operating system may reduce an amount of work scheduled on one or more cores which are indicated as operating below but “near” a crossover point, at the crossover point, and/or above the crossover point (e.g., in an inefficient state) while continuing to operate those one or more cores at a particular frequency (e.g., to achieve at least a predefined throughput, or a computed throughput given the workload of the system).

The described approach provides several advantages over conventional approaches. By accounting for changes in core efficiency at different frequencies, the system can optimize power consumption across a wide range of operating conditions. This may result in significant energy savings, particularly in devices with constrained power budgets. Moreover, the dynamic scheduling approach allows the system to leverage the full capabilities of each core while avoiding inefficient operating states. This may lead to improved overall system performance compared to static scheduling or frequency capping methods. Moreover, the system can adapt to variations in core efficiency due to manufacturing tolerances, wear, or environmental factors. This ensures optimal performance and efficiency throughout the lifetime of the device. Additionally, by monitoring core efficiency at runtime and providing feedback to the operating system, the system can make more informed scheduling decisions than those based solely on core type or static efficiency assumptions.

Notably, the approach can be applied to various heterogeneous architectures, such as by accommodating different combinations of high-performance and efficiency cores. By avoiding inefficient operating states, the system may generate less heat, potentially improving device reliability and reducing the need for aggressive cooling solutions. The dynamic scheduling approach may result in smoother performance and longer battery life in devices (e.g., mobile devices and laptops), enhancing the overall user experience. The system can work alongside existing power management techniques, providing an additional layer of optimization without requiring a complete overhaul of existing architectures. The approach can be applied to systems with varying numbers and types of cores, making it suitable for a wide range of devices from mobile phones to high-performance computing systems. As processor architectures continue to evolve, this adaptive approach to core scheduling may become increasingly valuable in managing complex heterogeneous systems.

In some aspects, the techniques described herein relate to a computing device including: a plurality of cores, a controller, the controller configured to communicate feedback associated with efficiency of the plurality of cores, and an operating system configured to receive the feedback and adjust core scheduling responsive to at least one of the plurality of cores operating in an inefficient state based on the feedback.

In some aspects, the techniques described herein relate to a computing device, wherein the controller is further configured to: monitor operation of the plurality of cores, and detect that an operating frequency of at least one core of the plurality of cores is proximate to a crossover point, wherein the crossover point indicates a transition between a first frequency range in which the at least one core executes threads relatively efficiently and a second frequency range in which the at least one core executes threads relatively less efficiently.

In some aspects, the techniques described herein relate to a computing device, wherein the controller is configured to communicate the feedback to the operating system based on detecting that the operating frequency of the at least one core is proximate to the crossover point.

In some aspects, the techniques described herein relate to a computing device, wherein the crossover point is based on at least one of voltage or frequency fused in the plurality of cores.

In some aspects, the techniques described herein relate to a computing device, wherein the plurality of cores includes at least one high-performance core and at least one efficiency core.

In some aspects, the techniques described herein relate to a computing device, wherein adjusting core scheduling includes migrating work from a first core operating in an inefficient state to a second core operating in a relatively more efficient state.

In some aspects, the techniques described herein relate to a computing device, wherein adjusting core scheduling includes reducing an amount of work scheduled on at least one core operating in an inefficient state while maintaining a particular operating frequency for the at least one core.

In some aspects, the techniques described herein relate to a computing device, wherein the feedback indicates that a first core has transitioned from being less efficient than a second core at executing threads to being more efficient than the second core at executing threads.

In some aspects, the techniques described herein relate to a computing device, wherein the controller is further configured to: detect crossover points for each of the plurality of cores, wherein each crossover point indicates a transition between a first frequency range in which a respective core executes threads relatively efficiently and a second frequency range in which the respective core executes threads relatively less efficiently, and store the detected crossover points for each of the plurality of cores.

In some aspects, the techniques described herein relate to a method including: monitoring, by a controller, operation of a plurality of cores, detecting, by the controller, that an operating frequency of at least one core of the plurality of cores is proximate to a crossover point, wherein the crossover point indicates a transition between a first frequency range in which the at least one core executes threads relatively efficiently and a second frequency range in which the at least one core executes threads relatively less efficiently, and communicating, by the controller to an operating system, feedback associated with efficiency of the at least one core to enable the operating system to adjust core scheduling responsive to the feedback.

In some aspects, the techniques described herein relate to a method, wherein communicating the feedback to the operating system is based on detecting that the operating frequency of the at least one core is proximate to the crossover point.

In some aspects, the techniques described herein relate to a method, wherein the plurality of cores includes at least one high-performance core and at least one efficiency core.

In some aspects, the techniques described herein relate to a method, wherein adjusting core scheduling includes migrating work from a first core operating in an inefficient state to a second core operating in a relatively more efficient state.

In some aspects, the techniques described herein relate to a method, wherein adjusting core scheduling includes reducing an amount of work scheduled on at least one core operating in an inefficient state while maintaining a particular operating frequency for the at least one core.

In some aspects, the techniques described herein relate to a method, wherein determining the crossover point is based on at least one of voltage or frequency fused in the plurality of cores.

In some aspects, the techniques described herein relate to a method, further including: detecting crossover points for each of the plurality of cores, wherein each crossover point indicates a transition between a first frequency range in which a respective core executes threads relatively efficiently and a second frequency range in which the respective core executes threads relatively less efficiently, and storing the detected crossover points for each of the plurality of cores.

In some aspects, the techniques described herein relate to a system including: a controller communicatively coupled to a processing unit having a plurality of cores, the controller configured to communicate feedback associated with efficiency of the plurality of cores, the feedback enabling an operating system to adjust core scheduling responsive to at least one core of the plurality of cores operating in an inefficient state based on the feedback.

In some aspects, the techniques described herein relate to a system, wherein the controller is further configured to: monitor operation of a plurality of cores, and detect that an operating frequency of at least one core of the plurality of cores is proximate to a crossover point, wherein the crossover point indicates a transition between a first frequency range and a second frequency range.

In some aspects, the techniques described herein relate to a system, wherein the controller is configured to communicate the feedback based on detecting that the operating frequency of the at least one core is proximate to the crossover point.

In some aspects, the techniques described herein relate to a system, wherein the plurality of cores includes at least one high-performance core and at least one efficiency core.

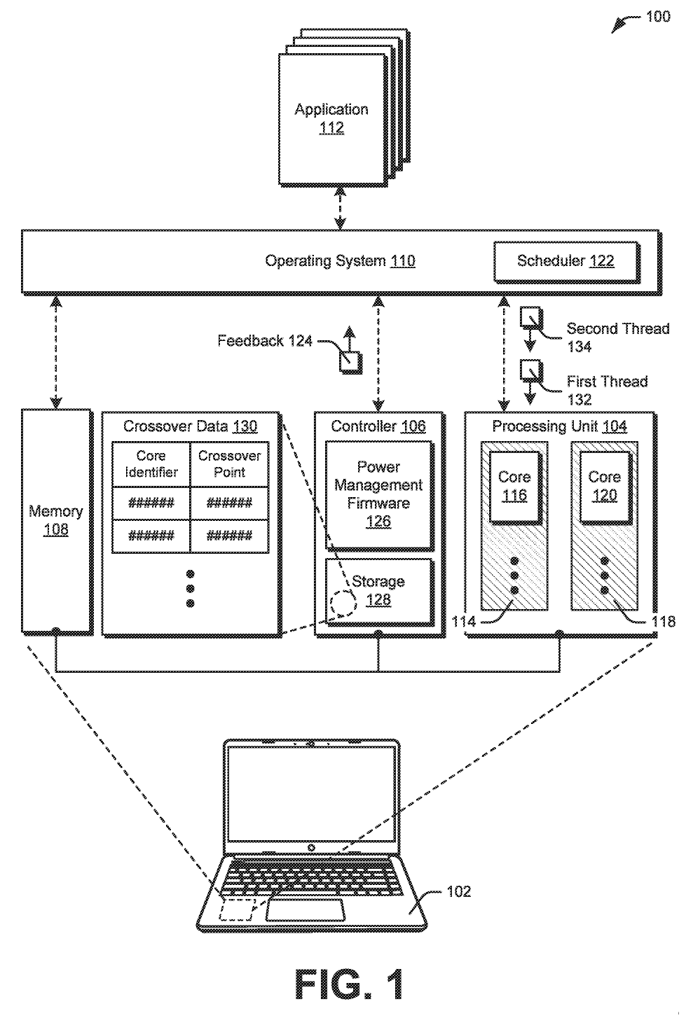

FIG. 1 is a block diagram of a non-limiting example system 100 which has a heterogeneous architecture and is configured to schedule cores based on energy crossover.

The system 100 with the heterogenous architecture is implemented at one or more computing devices, such as computing device 102. In one or more implementations, the system 100 includes one or more of a processing unit 104, a controller 106, and a memory 108. The processing unit 104, the controller 106, and the memory 108 are operable to implement an operating system 110 (one example of an application) and one or more applications 112 which run on top of the operating system 110.

In accordance with the described techniques, the processing unit 104 includes at least a first set of cores 114 having at least one core 116 (e.g., a first type of core) and a second set of cores 118 also having at least one core 120 (e.g., a second type of core). To implement a heterogenous architecture, different types of cores and/or cores having different characteristics are incorporated in an architecture, e.g., included in the processing unit 104. In the context of the illustrated example, for instance, the core 116 is a different core type from the core 120. In other words, the at least one core 116 has one or more different characteristics from the at least one core 120, such as different power/frequency and/or different voltage/frequency characteristics. In at least one implementation, the core 116 and the core 120 have different microarchitectures. As used herein, the term “set of cores” means one or more cores. Thus, the first set of cores 114 includes one or more cores, including at least the core 116. Similarly, the second set of cores 118 includes one or more cores, including at least the core 120. In at least one variation, the processing unit 104 includes more than two sets of cores, e.g., the processing unit 104 includes at least three different types of cores and thus three sets of cores.

One example core type is a performance core or “high-performance core,” which generally executes instructions, also referred to herein as “threads,” at a higher frequency (e.g., executes more instructions in a given interval of time) than other types of cores. In order to execute instructions at such a higher frequency, however, performance cores may generally consume more power than other types of cores, e.g., cores that execute instructions at a lower frequency. Performance cores may be ideally suited to execute instructions for tasks where low latency (or high throughput) is preferred, such as in connection with productivity tasks (e.g., spreadsheets), securities trading, physics engines for gaming applications, and so on.

Another example core type is an efficiency core. As used herein, an “efficiency core” refers to a core that generally executes instructions at a lower frequency (e.g., executes fewer instructions in the given interval of time) than other types of cores. By executing instructions at a lower frequency, efficiency cores may consume less power than other types of cores, e.g., cores that execute instructions at a higher frequency. Efficiency cores may be ideally suited to execute instructions for tasks where more latency is acceptable or preferred, such as for graphics (e.g., displaying video during a video conference “call”) and for artificial intelligence applications (e.g., training and/or inference). In addition to operating at higher or lower frequencies and consuming more or less power, a particular core type can have one or more other characteristics which distinguish it from other core types.

The inclusion of different core types in the architecture is beneficial because it enables the system 100 to take advantage of the characteristics of the different core types for heterogenous workloads. Consider an example in which a user of the computing device 102 utilizes a video conferencing application (e.g., to conduct a video conference) while simultaneously utilizing a spreadsheet application (e.g., to model some financial situation). The workload is heterogenous because the different tasks are associated with different characteristics or “expectations.” For instance, users expect productivity tools (and thus tasks) to respond instantaneously or near instantaneously to user input, whereas users do not expect tasks such as video display to be output at a greater frame rate than the human eye is capable of perceiving.

With conventional approaches, heterogenous systems may schedule tasks to the cores of a processing unit solely based on core type. For example, such conventional systems may schedule tasks that benefit from high performance to performance cores and tasks that are relatively tolerant of latency to efficiency cores, without considering other runtime characteristics of or observations about those cores. As part of this, conventional approaches leverage CPUID, which reports about the architecture of a processing unit to an operating system. This includes reporting core types of the architecture’s cores to the operating system. When scheduling tasks to the cores of a heterogeneous architecture, a conventionally configured scheduler evaluates the core types of the cores as indicated by CPUID and directs a task to a core based on its core type as indicated by CPUID. However, this simplistic approach fails to account for changes in efficiency (in terms of power consumption) of the cores when operating at different (e.g., higher, or lower) frequencies.

Alternatively or additionally, in conventional approaches, firmware of the processing unit restricts (e.g., caps) a frequency at which cores execute threads, using one or more known techniques for restricting the frequency. However, this limits the throughput (or “performance”) of the cores to the frequency cap, i.e., the frequency at the cap is the maximum rate at which the cores can execute threads. In one or more such approaches, the processing unit firmware restricts the frequency without interacting with an operating system. Alternatively or additionally, in some conventional approaches, an operating system performs one or more actions that limit the throughput of the cores, such as by using one or more Advanced Configuration and Power Interface (ACPI) mechanisms. In contrast to such conventional techniques, the system 100 accounts for changes in efficiency of cores at different frequencies when scheduling the cores, e.g., of the heterogeneous architecture, to execute one or more threads.

Here, the operating system 110 includes scheduler 122. Whether implemented in software of the operating system 110 as depicted or implemented in hardware of another component of the system 100, the scheduler 122 is configured to schedule the components of the system 100, e.g., the processing unit 104, the controller 106, and the memory 108, to perform different tasks. For example, the scheduler 122 is configured to schedule a core of the first set of cores 114 and/or a core of the second set of cores 118 to execute one or more threads.

In contrast to conventionally configured schedulers, however, the scheduler 122 is capable of scheduling execution of a thread on one or more cores in a manner that accounts for changes in efficiency (in terms of power consumption) of the cores at different frequencies (e.g., of executing threads per interval of time). For example, the scheduler 122 is capable of adjusting the scheduling of a thread on one or more cores in a manner that accounts for changes in efficiency of different core types and/or of individual cores (e.g., due to manufacturing tolerances and/or wear) across a range of operating frequencies.

In order to do so, in one or more implementations, one or more of the hardware components of the system 100 provide feedback 124 to the operating system 110 during runtime. By way of example, the feedback 124 indicates that a crossover point has been reached at which a core transitions between a first frequency range and a second frequency range, where in the first frequency range the core executes threads relatively efficiently and in the second frequency range the core executes threads relatively less efficiently, or vice versa. Alternatively or additionally, the feedback 124 indicates that a crossover point has been reached at which a first core (or core type) transitions from being less efficient (in terms of power consumption) than a second core (or core type) at executing threads to being more efficient (in terms of power consumption) than the second core (or core type) at executing threads.

In the illustrated example, the controller 106 includes power management firmware 126 and storage 128, which is configured to maintain crossover data 130. In one or more implementations, the controller 106 is a power management controller, which manages power of various components of the system 100, such as by running the power management firmware 126. In at least one implementation, the controller 106 is implemented as a microprocessor that is separate from the processing unit 104, and the microprocessor’s operation is controlled by the power management firmware 126.

Although depicted as separate from the processing unit 104 and the memory 108, in at least one variation, portions of the controller 106 (e.g., the power management firmware 126 and/or the storage 128 with the crossover data 130) are implemented entirely or in part using one or more different components of the system 100. In at least one implementation, for instance, the processing unit 104 includes the power management firmware 126 and/or the storage 128 with the crossover data 130. Further, the storage 128 is implementable in a variety of ways, such as by using at least one register, such as a model-specific register (MSR) (e.g., of the processing unit 104), flash memory, and/or static random access memory (SRAM).

Although discussed below as being performed by the power management firmware 126, in variations, one or more different components of the system 100 are capable of performing one or more of: deriving the crossover data 130, monitoring performance of the processing unit 104’s cores during operation, and, based on the monitoring, providing feedback 124 to the operating system 110 when operation of the cores is proximate a crossover point, such as before operation reaches the crossover point, at the crossover point, or after operation reaches the crossover point.

In one or more scenarios, therefore, the feedback 124 is provided proximate a crossover point where an individual core transitions between a first frequency range and a second frequency range and/or where a first core (or core type) has become more efficient at executing threads than a second core (or core type), when previously the second core (or core type) had been more efficient at executing threads.

In at least one variation, for example, the functionality of the power management firmware 126 discussed below is performed by software executing out of the memory 108 on at least core (e.g., the core 116 and/or the core 120) of the processing unit 104. Alternatively or additionally, the functionality of the power management firmware 126 is implemented in hardware, e.g., in circuitry of an IP block of a component of the system 100.

In accordance with the described techniques, the power management firmware 126 determines the crossover point of a core of the processing unit 104. In one or more implementations, for example, the power management firmware 126 calculates the crossover points of the cores of the processing unit 104 at different operating points (e.g., different frequencies at which threads can be executed by the cores) based on at least one of voltage or frequency fused in the cores. Alternatively or additionally, the power management firmware 126 derives the crossover points by causing microbenchmarks to be run on the system 100 at any of a variety of different frequencies (e.g., at 1 gigahertz, 1.5 gigahertz, 2 gigahertz, 2.5 gigahertz, 3 gigahertz, 3.5 gigahertz, and so on) and by monitoring (e.g., detecting) and recording the power consumed by the cores when the microbenchmarks are run at each of the different frequencies.

In one or more implementations, the power management firmware 126 records the calculated or otherwise determined crossover points in the crossover data 130. By way of example, the crossover data 130 maps each of the cores of the processing unit 104 to a respective crossover point calculated or otherwise determined for the core. For instance, the crossover data 130 associates an identifier of an individual core with the determined crossover point of the core. In at least one implementation, the crossover data 130 is configured as a table or database that maps the individual cores to their respective crossover points. In variations, the crossover data 130 is implemented via other mechanisms (from a table or database) capable of mapping a core to a determined crossover point of the core. In accordance with the described techniques, the crossover data 130 is capable of being referenced, e.g., by the power management firmware 126 or by some other component of the system, to retrieve the crossover point for a given core.

During operation of the processing unit 104 – while one or more cores of the processing unit 104 execute one or more threads – the power management firmware 126 monitors the operation. For instance, the power management firmware 126 monitors the frequency at which the cores (each of the cores) execute threads. Further, the power management firmware 126 is configured to detect when a core is near its crossover point, e.g., within a threshold below the crossover point, at the crossover point, or within a threshold above the crossover point. For example, the power management firmware 126 detects when a core is near its crossover point by using the crossover data 130 and one or more frequencies observed through monitoring the processing unit 104. In one or more implementations, for instance, the power management firmware 126 is capable of referencing the crossover data 130 and comparing an observed frequency at which a core is operating to the crossover point specified in the crossover data 130 for the core.

In accordance with the described techniques, the power management firmware 126 is also configured to provide the feedback 124, which is associated with the efficiency of the cores of the processing unit 104. In one or more implementations, the power management firmware 126 is configured to selectively communicate the feedback 124 to the operating system 110 based on the observed frequency at which a core is operating and the crossover point of the core. For instance, when the frequency at which a core operates or is scheduled to operate is at or exceeds the crossover point of the core, the power management firmware 126 can detect this and provide the feedback 124 to the operating system 110. In at least one implementation, the feedback 124 is communicated when sustained use of a first core is at a frequency above the first core’s crossover point (e.g., in an inefficient state for the first core) while a second core capable of operating in an efficient state or more efficiently at the frequency is available and/or idle. Additionally or alternatively, the power management firmware 126 can communicate the feedback 124 to another component, such as a different processing unit of the system 100.

In one or more implementations, the power management firmware 126 communicates the feedback 124 responsive solely to detecting that an operating frequency of a core is near its crossover point. As noted above, though, in at least one variation, the power management firmware 126 is configured to “selectively communicate” the feedback 124, e.g., to the operating system 110.

Notably, the power management firmware 126 may communicate the feedback 124 based on detecting a frequency near a core’s crossover point, unless the power management firmware 126 also determines that one or more operating conditions for refraining from communicating the feedback 124 are satisfied. In one or more implementations, conditions or scenarios which, if determined, cause the power management firmware 126 to refrain from communicating the feedback 124 include but are not limited to: multithreaded workload scenarios where the cores (e.g., all the cores of the processing unit 104) are used at a maximum frequency, resulting in one or more of the cores operating at or above the crossover point, and bursty workload scenarios where one or more of the cores temporarily operate above the crossover point for an interval of time (e.g., less than a threshold amount of time). It is to be appreciated that in variations, the power management firmware 126 refrains from communicating the feedback 124 based on the occurrence of other conditions in accordance with the described techniques.

In variations, the feedback 124 is provided (e.g., to the operating system 110) in different ways. In at least one implementation, for instance, the feedback 124 is provided to the operating system 110 via at least one model-specific register (MSR). In such implementations, the storage 128 corresponds to at least one MSR, which the operating system 110 is configured to monitor (e.g., continuously), such that the operating system 110 is capable of using the information stored in the at least one MSR as a basis for making scheduling decisions. Further, in such implementations, the power management firmware 126 may be able to populate the at least one MSR with the feedback 124, e.g., indicating that a core is proximate (e.g., at or has exceeded) its crossover point.

Alternatively or additionally, in one or more implementations, the feedback 124 is a firmware notification to the operating system 110 communicated via one or more defined interfaces and which indicates that a given core is operating above its crossover point. In at least one implementation, the feedback 124 provides information about more than one core. For example, the feedback 124 indicates any cores of the processing unit 104 that are operating above their respective crossover points. In at least one implementation, the feedback 124 provides more information than simply whether cores are above respective crossover points, examples of which include by how much cores are above or below crossover points, how long cores have been above or below crossover points, whether cores are below respective crossover points, and so forth.

Based on the feedback 124, the operating system 110, e.g., the scheduler 122, is configured to perform any of a variety of operations to adjust scheduling threads on the cores for execution. For example, the operating system 110 is configured to stop scheduling threads to one or more cores which are indicated as operating below but “near” a crossover point, at the crossover point, and/or above the crossover point (e.g., in an inefficient state), and instead to migrate the work onto one or more cores operating more efficiently (e.g., below the crossover point in an efficient state). Alternatively or additionally, the operating system 110 is configured to reduce an amount of work scheduled on one or more cores which are indicated as operating below but “near” a crossover point, at the crossover point, and/or above the crossover point (e.g., in an inefficient state) while continuing to operate those one or more cores at a particular frequency (e.g., to achieve at least a predefined throughput, or a computed throughput given the workload of the system).

As one example, FIG. 1 also depicts a first thread 132 and a second thread 134. In this example, consider a scenario in which the operating system 110 schedules the first thread 132 for execution on the core 116. During this execution, the power management firmware 126 monitors execution of the cores of the processing unit 104, e.g., the power management firmware 126 monitors the frequency at which the cores are operating. In this example, based on the monitoring, the power management firmware 126 detects that the core 116 operates at a frequency which exceeds the crossover point of the core 116, as indicated in the crossover data 130. Responsive to the detection, the power management firmware 126 provides feedback 124 to the operating system 110, where the feedback 124 indicates at least that the core 116 operates at a frequency above its crossover point and may also indicate that another core (e.g., the core 120) which is more efficient is available and/or idle. Based on the feedback 124, the operating system 110 can stop scheduling work (e.g., threads) to the core 116 and instead migrate work (e.g., threads) to more efficient cores (e.g., the core 120). Given this, the operating system 110 schedules the second thread 134 (which is subsequent to the first thread 132) to the core 120 rather than to the core 116.

It is to be appreciated that the processing unit 104 is configurable as any of a variety of types of processing unit in different implementations, examples of which include but are not limited to a central processing unit (CPU), a graphics processing unit (GPU), an accelerator unit (AU), a neural processing unit (NPU) or other artificial intelligence processing unit, an inference processing unit (IPU), a digital signal processor, or a field programmable gate array, to name just a few.

Although the computing device 102 is depicted as a laptop in the illustrated example. In variations, the computing device 102 may be any of a variety of other types of computing devices, examples of which include but are not limited to, a server computer, a personal computer (e.g., a desktop or tower computer), a smartphone or other wireless phone, a tablet or phablet computer, a notebook computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

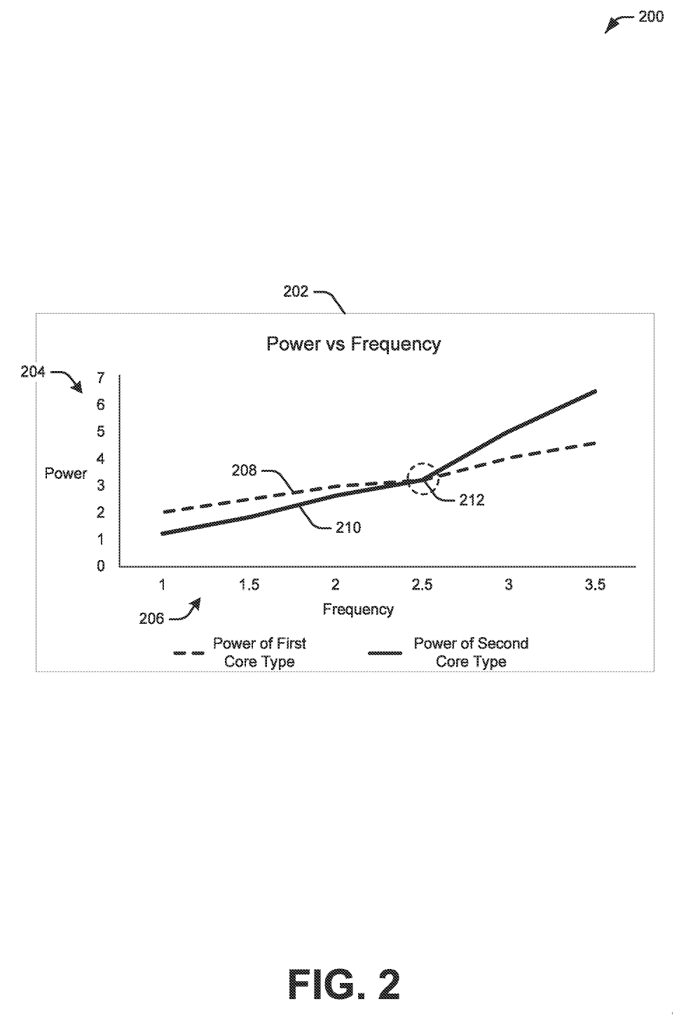

Further, the processing unit 104, the controller 106, the memory 108, and/or any other components of the computing device 102 are connected using any of a variety of wired or wireless connections. Examples of connections which are usable to communicably couple those components include but are not limited to, buses (e.g., a data bus, a system, an address bus), interconnects, memory channels, through silicon vias, traces, and planes. Other example connections include optical connections, fiber optic connections, and/or connections or links based on quantum entanglement. Similarly, the components of the processing unit 104 – the first set of cores 114 and the second set of cores 120 – are connected using any of a variety of wired or wireless connections. In the context of crossover points for different types of cores, where the different types transition from an efficient state of operating to an inefficient state of operating, consider the following discussion of FIG. 2.

FIG. 2 is a non-limiting example 200 of a graph which plots power consumption against frequency for two different core types and show a crossover point.

The illustrated example 200 depicts graph 202 which plots power along a first axis 204 (i.e., the y-axis) against frequency (e.g., number of threads or other operations executed per unit of time) along a second axis 206 (i.e., the x-axis). In particular, the graph 202 plots power of a first core type 208 and power of a second core type 210 at different frequencies.

The graph 202 also shows crossover point 212 – a frequency of execution at which both the first core type and the second core type become less efficient at executing threads. In this example 200, the crossover point 212 is an inflection point above which the amount of power consumed increases more rapidly than at frequencies below the inflection point. For both core types, the plotted power of the first core type 208 and power of the second core type 210 indicates that below the crossover point 212 both core types operate in an efficient state and after the crossover point 212 both core types operate in an inefficient state.

However, below the crossover point 212, the graph 202 shows that the second core type is more efficient than the first core type, e.g., the second core type consumes less power than the first type when executing threads at a same frequency below the crossover point 212. It follows then that the first core type is less efficient than the second core type below the crossover point 212, e.g., the first core type consumes more power than the second core type when executing threads at a same frequency below the crossover point 212. Thus, at frequencies below the crossover point 212, the power management firmware 126 may provide feedback 124 that causes the operating system 110 to schedule threads to cores of the first core type.

By way of contrast, above the crossover point 212, the graph 202 shows that the first core type is more efficient than the second core type, e.g., the first core type consumes less power than the second core type when executing threads at a same frequency above the crossover point 212. It follows then that the second core type is less efficient than the first core type above the crossover point 212, e.g., the second core type consumes more power than the first core type when executing threads at a same frequency above the crossover point 212. Thus, at frequencies above the crossover point 212, the power management firmware 126 may provide feedback 124 that causes the operating system 110 to schedule threads to cores of the second core type.

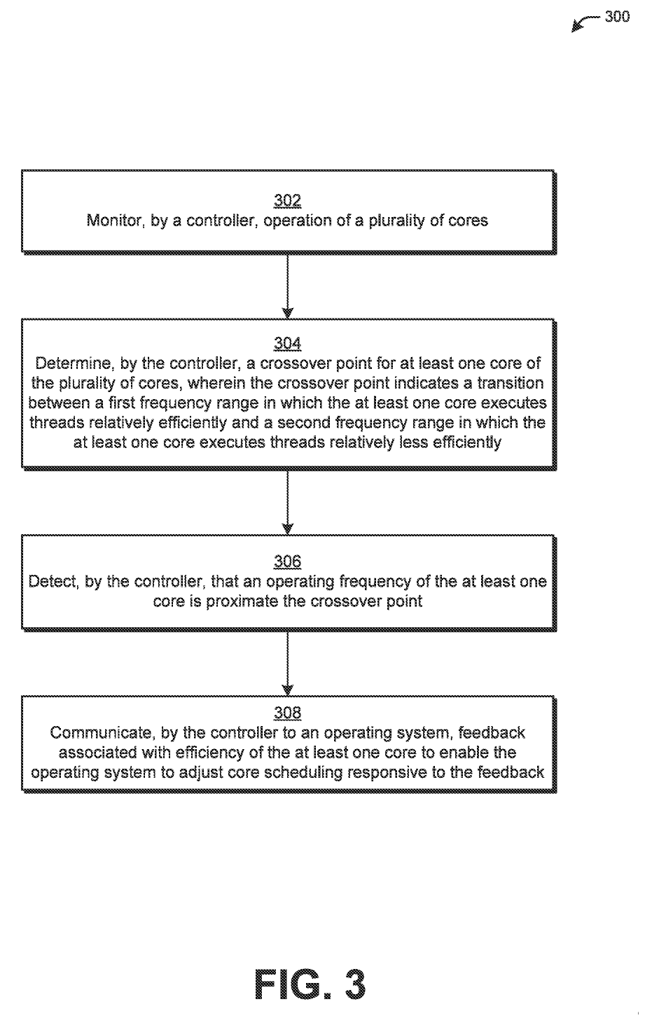

FIG. 3 depicts a non-limiting example procedure 300 for core scheduling based on energy crossover.

Operation of a plurality of cores is monitored by a controller (block 302). By way of example, controller 106 monitors operation of a plurality of cores, such as cores 116 and 120 of processing unit 104. In one or more implementations, the controller 106 may continuously monitor various operational parameters of the cores. These parameters may include, but are not limited to, the current operating frequency of each core, the power consumption of each core, the temperature of each core, and the workload or utilization level of each core. The monitoring process may involve reading data from various sensors and registers associated with each core. For instance, the controller 106 may periodically sample performance counters, power sensors, and temperature sensors for each core. In some cases, the controller 106 may also track the types of instructions or threads being executed on each core.

The monitoring may occur at regular intervals, such as every few milliseconds or microseconds, depending on the specific implementation and desired granularity of control. Alternatively, the monitoring may be event-driven, triggered by certain conditions such as sudden changes in workload or temperature. In one or more implementations, the controller 106 may maintain a history of the monitored parameters for each core. This historical data may be used to identify trends or patterns in core behavior over time, which can inform more sophisticated scheduling decisions. The monitoring process may also involve comparing the current operational parameters of each core to predetermined thresholds or to the core’s known characteristics, such as its crossover point. This comparison allows the controller 106 to quickly identify when a core is approaching or has crossed into a less efficient operational state.

A crossover point for at least one core of the plurality of cores is determined by the controller (block 304). In accordance with the principles discussed herein, the crossover point indicates a transition between a first frequency range in which the at least one core executes threads relatively efficiently and a second frequency range in which the at least one core executes threads relatively less efficiently. By way of example, controller 106 determines a crossover point for at least one core (e.g., core 116 or core 120) of a plurality of cores of the processing unit 104. The determination of the crossover point by the controller may involve several steps and considerations. In some implementations, the controller may use a combination of static information and dynamic measurements to accurately determine the crossover point for each core.

The static information may include manufacturer-provided specifications for each core type, such as power consumption curves, voltage-frequency characteristics, and thermal properties. This information may be stored in the crossover data 130 and used as a starting point for determining the crossover point.

Dynamic measurements may involve running a series of benchmark tests on each core at various frequencies and measuring the power consumption and performance. These tests may be performed during system initialization or periodically during operation to account for changes in core behavior due to factors such as temperature variations or aging.

In some implementations, the controller may use machine learning techniques to refine its determination of the crossover point over time. By correlating observed power consumption and performance with various operational parameters, the controller may be able to predict the crossover point more accurately for different workload types and environmental conditions. The crossover point determination may also take into account system-level considerations. For example, the controller may adjust the crossover point based on the current power state of the device, such as whether it is running on battery power or connected to an external power source.

Once the crossover point is determined, the controller may store this information in the crossover data 130 for quick reference during runtime. The controller may also establish hysteresis bands around the crossover point to prevent rapid switching between efficiency states due to small fluctuations in operating frequency.

It's important to note that the crossover point may not be a single, fixed frequency for all situations. Instead, it may be a range of frequencies that varies based on factors such as workload type, temperature, and overall system load. The controller may maintain multiple crossover points or curves for different scenarios to ensure optimal efficiency across a wide range of operating conditions.

The controller detects that an operating frequency of the at least one core is proximate to the crossover point (block 306). By way of example, the controller 106 detects that an operating frequency of the at least one core is proximate to the crossover point. In this step, the controller 106 is actively monitoring the operating frequency of at least one core in the system.

The crossover point is a specific frequency or range at which the core transitions from operating in an efficient state to a less efficient state, or vice versa. As noted above, this transition point is typically determined based on factors such as power consumption and performance characteristics of the core. When the controller 106 detects that the operating frequency of a core is near this crossover point, it signals a core transition from an efficient state to a less efficient state, or vice versa. This detection is a trigger for the controller 106 to take action, such as by communicating feedback to the operating system 110. This feedback is used to inform the operating system 110 about the efficiency state of the core, which can then be used to make informed decisions about scheduling tasks on the cores to optimize overall system performance and energy efficiency.

Feedback associated with efficiency of the at least one core is communicated by the controller to an operating system to enable the operating system to adjust core scheduling responsive to the feedback (block 308). By way of example, the controller 106 communicates feedback 124 to the operating system 110 indicating that a core is operating near, at, or above its crossover point. This feedback enables the operating system 110 to adjust core scheduling, such as by migrating work from cores operating inefficiently to cores operating more efficiently. This migration of work helps to optimize the overall energy efficiency of the computing device by ensuring that tasks are executed on the cores that can perform them in the least power-consuming manner. In this way, the feedback from the controller serves as a dynamic guide for the operating system, enabling it to adjust its core scheduling strategy in real-time based on the current operating conditions of the cores. This dynamic adjustment of core scheduling can lead to improved energy efficiency and performance of the computing device.

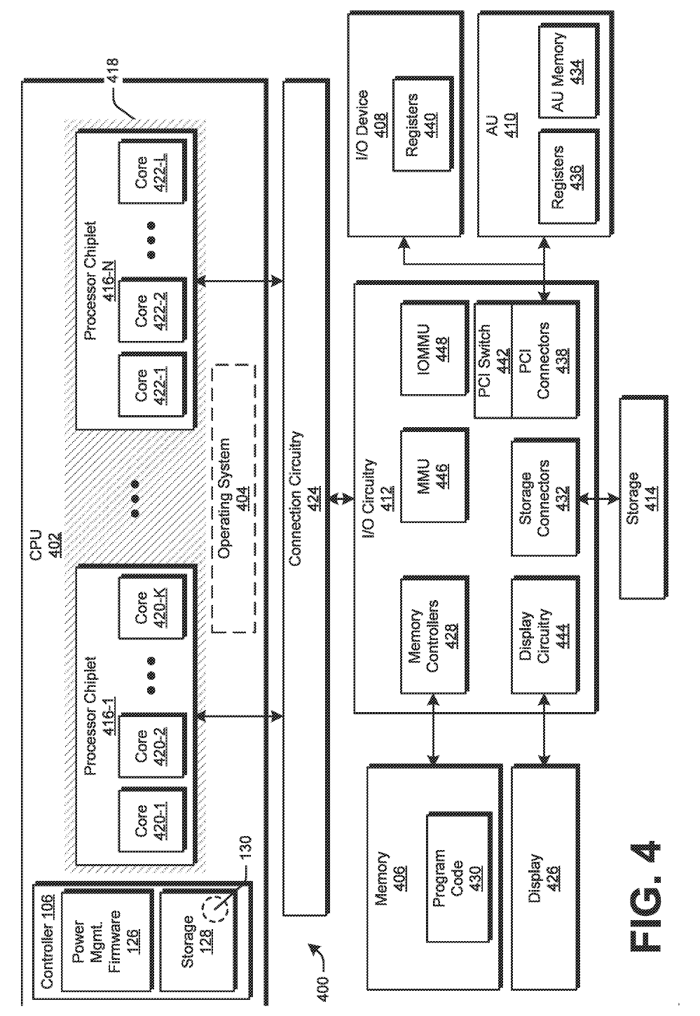

FIG. 4 is a block diagram of a processing system configured to execute one or more applications, in accordance with one or more implementations.

FIG. 4 includes a processing system 400 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 400 includes a central processing unit (CPU) 402. In one or more implementations, the CPU 402 is configured to run an operating system (OS) 404 that manages the execution of applications. For example, the OS 404 is configured to schedule the execution of tasks (e.g., threads) for applications, allocate portions of resources (e.g., system memory 406, CPU 402, input/output (I/O) device 408, accelerator unit (AU) 410, storage 414) for the execution of tasks for the applications, provide an interface to I/O devices (e.g., I/O device 408) for the applications, or any combination thereof.

In this example, the controller 106 having the power management firmware 126 and the storage 128 with the crossover data 130 is depicted in the CPU 402. In variations, however, the controller 106 and/or the power management firmware 126 are included in and/or are implemented by one or more different components of the processing system 400, such as the memory 406, the I/O device 408, the AU 410, the I/O circuitry 412, the storage 414, and so forth. In at least one implementation, the controller 106 having the power management firmware 126 and the storage 128 with the crossover data 130 or portions thereof are included in at least two of the depicted components of the processing system 400.

The CPU 402 includes one or more processor chiplets 416, which are communicatively coupled together by a data fabric 418 in one or more implementations.

Each of the processor chiplets 416, for example, includes one or more processor cores 420, 422 configured to concurrently execute one or more series of instructions, also referred to herein as “threads,” for an application. Further, the data fabric 418 communicatively couples each processor chiplet 416-N of the CPU 402 such that each processor core (e.g., processor cores 420) of a first processor chiplet (e.g., 416-1) is communicatively coupled to each processor core (e.g., processor cores 422) of one or more other processor chiplets 416. Though the example embodiment presented in FIG. 4 shows a first processor chiplet (416-1) having three processor cores (420-1, 420-2, 420-K) representing a K number of processor cores 422 and a second processor chiplet (416-N) having three processor cores (e.g., 422-1, 422-2, 422-L) representing an L number of processor cores 422, in other implementations (L being an integer number greater than or equal to one), each processor chiplet 416 may have any number of processor cores 420, 422. For example, each processor chiplet 416 can have the same number of processor cores 420, 422 as one or more other processor chiplets 416, a different number of processor cores 420, 422 as one or more other processor chiplets 416, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

Additionally, within the processing system 400, the CPU 402 is communicatively coupled to an I/O circuitry 412 by a connection circuitry 424. For example, each processor chiplet 416 of the CPU 402 is communicatively coupled to the I/O circuitry 412 by the connection circuitry 424. The connection circuitry 424 includes, for example, one or more data fabrics, buses, buffers, queues, and the like. The I/O circuitry 412 is configured to facilitate communications between two or more components of the processing system 400 such as between the CPU 402, system memory 406, display 426, universal serial bus (USB) devices, peripheral component interconnect (PCI) devices (e.g., I/O device 408, AU 410), storage 414, and the like.

As an example, system memory 406 includes any combination of one or more volatile memories and/or one or more non-volatile memories, examples of which include dynamic random-access memory (DRAM), static random-access memory (SRAM), non-volatile RAM, and the like. To manage access to the system memory 406 by CPU 402, the I/O device 408, the AU 410, and/or any other components, the I/O circuitry 412 includes one or more memory controllers 428. These memory controllers 428, for example, include circuitry configured to manage and fulfill memory access requests issued from the CPU 402, the I/O device 408, the AU 410, or any combination thereof. Examples of such requests include read requests, write requests, fetch requests, pre-fetch requests, or any combination thereof. That is to say, these memory controllers 428 are configured to manage access to the data stored at one or more memory addresses within the system memory 406, such as by CPU 402, the I/O device 408, and/or the AU 410.

When an application is to be executed by processing system 400, the OS 404 running on the CPU 402 is configured to load at least a portion of program code 430 (e.g., an executable file) associated with the application from, for example, a storage 414 into system memory 406. This storage 414, for example, includes a non-volatile storage such as a flash memory, solid-state memory, hard disk, optical disc, or the like configured to store program code 430 for one or more applications.

To facilitate communication between the storage 414 and other components of processing system 400, the I/O circuitry 412 includes one or more storage connectors 432 (e.g., universal serial bus (USB) connectors, serial AT attachment (SATA) connectors, PCI Express (PCIe) connectors) configured to communicatively couple storage 414 to the I/O circuitry 412 such that I/O circuitry 412 is capable of routing signals to and from the storage 414 to one or more other components of the processing system 400.

In association with executing an application, in one or more scenarios, the CPU 402 is configured to issue one or more instructions (e.g., threads) to be executed for an application to the AU 410. The AU 410 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 410 includes one or more compute units that concurrently execute one or more threads of an application and store data resulting from the execution of these threads in AU memory 434. This AU memory 434, for example, includes any combination of one or more volatile memories and/or non-volatile memories, examples of which include caches, video RAM (VRAM), or the like. In one or more implementations, these compute units are also configured to execute these threads based on the data stored in one or more physical registers 436 of the AU 410.

To facilitate communication between the AU 410 and one or more other components of processing system 400, the I/O circuitry 412 includes or is otherwise connected to one or more connectors, such as PCI connectors 438 (e.g., PCIe connectors) each including circuitry configured to communicatively couple the AU 410 to the I/O circuitry such that the I/O circuitry 412 is capable of routing signals to and from the AU 410 to one or more other components of the processing system 400. Further, the PCIe connectors 438 are configured to communicatively couple the I/O device 408 to the I/O circuitry 412 such that the I/O circuitry 412 is capable of routing signals to and from the I/O device 408 to one or more other components of the processing system 400.

By way of example and not limitation, the I/O device 408 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 408 is configured to execute one or more operations, tasks, instructions, or any combination thereof based on one or more physical registers 440 of the I/O device 408. In one or more implementations, such physical registers 440 are configured to maintain data (e.g., operands, instructions, values, variables) indicating one or more operations, tasks, or instructions to be performed by the I/O device 408.

To manage communication between components of the processing system 400 (e.g., AU 410, I/O device 408) that are connected to PCI connectors 438, and one or more other components of the processing system 400, the I/O circuitry 412 includes PCI switch 442. The PCI switch 442, for example, includes circuitry configured to route packets to and from the components of the processing system 400 connected to the PCI connectors 438 as well as to the other components of the processing system 400. As an example, based on address data indicated in a packet received from a first component (e.g., CPU 402), the PCI switch 442 routes the packet to a corresponding component (e.g., AU 410) connected to the PCI connectors 438.

Based on the processing system 400 executing a graphics application, for instance, the CPU 402, the AU 410, or both are configured to execute one or more instructions (e.g., draw calls) such that a scene including one or more graphics objects is rendered. After rendering such a scene, the processing system 400 stores the scene in the storage 414, displays the scene on the display 426, or both. The display 426, for example, includes a cathode-ray tube (CRT) display, liquid crystal display (LCD), light emitting diode (LED) display, organic light emitting diode (OLED) display, or any combination thereof. To enable the processing system 400 to display a scene on the display 426, the I/O circuitry 412 includes display circuitry 444. The display circuitry 444, for example, includes high-definition multimedia interface (HDMI) connectors, DisplayPort connectors, digital visual interface (DVI) connectors, USB connectors, and the like, each including circuitry configured to communicatively couple the display 426 to the I/O circuitry 412. Additionally or alternatively, the display circuitry 444 includes circuitry configured to manage the display of one or more scenes on the display 426 such as display controllers, buffers, memory, or any combination thereof.

Further, the CPU 402, the AU 410, or both are configured to concurrently run one or more virtual machines (VMs), which are each configured to execute one or more corresponding applications. To manage communications between such VMs and the underlying resources of the processing system 400, such as any one or more components of processing system 400, including the CPU 402, the I/O device 408, the AU 410, and the system memory 406, the I/O circuitry 412 includes memory management unit (MMU) 446 and input-output memory management unit (IOMMU) 448. The MMU 446 includes, for example, circuitry configured to manage memory requests, such as from the CPU 402 to the system memory 406. For example, the MMU 446 is configured to handle memory requests issued from the CPU 402 and associated with a VM running on the CPU 402. These memory requests, for example, request access to read, write, fetch, or pre-fetch data residing at one or more virtual addresses (e.g., guest virtual addresses) each indicating one or more portions (e.g., physical memory addresses) of the system memory 406. Based on receiving a memory request from the CPU 402, the MMU 446 is configured to translate the virtual address indicated in the memory request to a physical address in the system memory 406 and to fulfill the request. The IOMMU 448 includes, for example, circuitry configured to manage memory requests (memory-mapped I/O (MMIO) requests) from the CPU 402 to the I/O device 408, the AU 410, or both, and to manage memory requests (direct memory access (DMA) requests) from the I/O device 408 or the AU 410 to the system memory 406. For example, to access the registers 440 of the I/O device 408, the registers 436 of the AU 410, and/or the AU memory 434, the CPU 402 issues one or more MMIO requests. Such MMIO requests each request access to read, write, fetch, or pre-fetch data residing at one or more virtual addresses (e.g., guest virtual addresses) which each represent at least a portion of the registers 440 of the I/O device 408, the registers 436 of the AU 410, or the AU memory 434, respectively. As another example, to access the system memory 406 without using the CPU 402, the I/O device 408, the AU 410, or both are configured to issue one or more DMA requests. Such DMA requests each request access to read, write, fetch, or pre-fetch data residing at one or more virtual addresses (e.g., device virtual addresses) which each represent at least a portion of the system memory 406. Based on receiving an MMIO request or DMA request, the IOMMU 448 is configured to translate the virtual address indicated in the MMIO or DMA request to a physical address and fulfill the request.

In variations, the processing system 400 can include any combination of the components depicted and described. For example, in at least one variation, the processing system 400 does not include one or more of the components depicted and described in relation to FIG. 4. Additionally or alternatively, in at least one variation, the processing system 400 includes additional and/or different components from those depicted. The 400 is configurable in a variety of ways with different combinations of components in accordance with the described techniques.

What is claimed is:

1. A computing device comprising:
a plurality of cores;
a controller, the controller configured to communicate feedback associated with efficiency of the plurality of cores; and
an operating system configured to receive the feedback and adjust core scheduling responsive to at least one of the plurality of cores operating in an inefficient state based on the feedback.

2. The computing device of claim 1, wherein the controller is further configured to:
monitor operation of the plurality of cores; and
detect that an operating frequency of at least one core of the plurality of cores is proximate to a crossover point, wherein the crossover point indicates a transition between a first frequency range in which the at least one core executes threads relatively efficiently and a second frequency range in which the at least one core executes threads relatively less efficiently.

3. The computing device of claim 2, wherein the controller is configured to communicate the feedback to the operating system based on detecting that the operating frequency of the at least one core is proximate to the crossover point.

4. The computing device of claim 2, wherein the crossover point is based on at least one of voltage or frequency fused in the plurality of cores.

5. The computing device of claim 1, wherein the plurality of cores comprises at least one high-performance core and at least one efficiency core.

6. The computing device of claim 1, wherein adjusting core scheduling comprises migrating work from a first core operating in an inefficient state to a second core operating in a relatively more efficient state.

7. The computing device of claim 1, wherein adjusting core scheduling comprises reducing an amount of work scheduled on at least one core operating in an inefficient state while maintaining a particular operating frequency for the at least one core.

8. The computing device of claim 1, wherein the feedback indicates that a first core has transitioned from being less efficient than a second core at executing threads to being more efficient than the second core at executing threads.

9. The computing device of claim 1, wherein the controller is further configured to:
detect crossover points for each of the plurality of cores, wherein each crossover point indicates a transition between a first frequency range in which a respective core executes threads relatively efficiently and a second frequency range in which the respective core executes threads relatively less efficiently; and
store the detected crossover points for each of the plurality of cores.

10. A method comprising:
monitoring, by a controller, operation of a plurality of cores;
detecting, by the controller, that an operating frequency of at least one core of the plurality of cores is proximate to a crossover point, wherein the crossover point indicates a transition between a first frequency range in which the at least one core executes threads relatively efficiently and a second frequency range in which the at least one core executes threads relatively less efficiently; and
communicating, by the controller to an operating system, feedback associated with efficiency of the at least one core to enable the operating system to adjust core scheduling responsive to the feedback.

11. The method of claim 10, wherein communicating the feedback to the operating system is based on detecting that the operating frequency of the at least one core is proximate to the crossover point.

12. The method of claim 10, wherein the plurality of cores comprises at least one high-performance core and at least one efficiency core.

13. The method of claim 10, wherein adjusting core scheduling comprises migrating work from a first core operating in an inefficient state to a second core operating in a relatively more efficient state.

14. The method of claim 10, wherein adjusting core scheduling comprises reducing an amount of work scheduled on at least one core operating in an inefficient state while maintaining a particular operating frequency for the at least one core.

15. The method of claim 10, wherein determining the crossover point is based on at least one of voltage or frequency fused in the plurality of cores.

16. The method of claim 10, further comprising:
detecting crossover points for each of the plurality of cores, wherein each crossover point indicates a transition between a first frequency range in which a respective core executes threads relatively efficiently and a second frequency range in which the respective core executes threads relatively less efficiently; and
storing the detected crossover points for each of the plurality of cores.

17. A system comprising:
a controller communicatively coupled to a processing unit having a plurality of cores, the controller configured to communicate feedback associated with efficiency of the plurality of cores, the feedback enabling an operating system to adjust core scheduling responsive to at least one core of the plurality of cores operating in an inefficient state based on the feedback.

18. The system of claim 17, wherein the controller is further configured to:
monitor operation of a plurality of cores; and
detect that an operating frequency of at least one core of the plurality of cores is proximate to a crossover point, wherein the crossover point indicates a transition between a first frequency range and a second frequency range.

19. The system of claim 18, wherein the controller is configured to communicate the feedback based on detecting that the operating frequency of the at least one core is proximate to the crossover point.

20. The system of claim 17, wherein the plurality of cores comprises at least one high-performance core and at least one efficiency core.
